(19) United States
(12) Patent Application Publication
(10) Pub. No.: US 2013/0071057 A1
(43) Pub. Date: Mar. 21, 2013

(54) ELECTRIC WHEEL DRIVE

(71) Applicants: Raphael Fischer, Herzogenaurach (DE); Michael Bogner, Eckental (DE); Tobias Vogler, Herzogenaurach (DE)

(72) Inventors: Raphael Fischer, Herzogenaurach (DE); Michael Bogner, Eckental (DE); Tobias Vogler, Herzogenaurach (DE)

(73) Assignee: Schaeffler Technologies AG & Co. KG, Herzongenaurach (DE)

(21) Appl. No.: 13/698,180

(22) PCT Filed: May 16, 2011
(86) PCT No.: PCT/EP11/57846

§ 371 Date: Nov. 15, 2012

(30) Foreign Application Priority Data
Jun. 1, 2010 (DE) 10 2010 022 320.4

(51) Int. Cl. F16C 41/00; F16C 19/00

(52) U.S. Cl. 384/476

(57) ABSTRACT

An electric wheel drive (1) includes a wheel bearing (2) which has two parts (3, 4) which can be rotated relative to one another, namely an inner part (3) and an outer part (4), wherein a potential equalization element (15) which makes contact with the inner part (3) on its end side (13) is fastened to the outer part (4).

### FIELD OF THE INVENTION

The present invention relates to an electric wheel drive of a road vehicle, in particular, a motor vehicle or a two-wheeled vehicle having an electric drive or an auxiliary electric drive.

### BACKGROUND

An electric wheel drive of a motor vehicle may be designed either as a direct drive such as is known, for example, from DE 10 2006 040 223 A1, or as an electric drive having a transmission is known in principle from EP 1 382 476 B1, for example. In both cases, electromagnetic compatibility regulations must be complied with. In particular, the electromagnetic radiation emitted during the operation of the motor vehicle must not exceed certain limits.

### SUMMARY OF THE INVENTION

It is an object of the present invention to minimize, in an electric wheel drive of a road vehicle, the emission of electromagnetic waves using simple means.

The present invention provides an electric wheel drive including a wheel bearing having two parts, namely an inner part and an outer part, which are rotatable relative to each other. The outer part has a potential equalization element attached thereto which contacts the inner part at the end face thereof.

An electrically conductive connection between a stator housing and a rotor shaft of an electric motor is known in principle from DE 101 62 818 A1. Various variants of the electrically conductive devices disclosed therein (FIGS. 1-7; 9-12) may in principle be used as a potential equalization element in the wheel bearing of the wheel drive according to the present invention.

In a preferred embodiment, the potential equalization element of the wheel bearing is configured as a covering cap. Alternatively, the potential equalization element may be configured as a metal bracket. In any case, electrically conductive contact between the outer part and the inner part of the wheel bearing is preferably established via a resilient contact member of the potential equalization element. The contact member which, depending on the embodiment, may be identical with, or a part of, the potential equalization element may, as a whole, have resilient properties or include a spring, which may be in the form of a coil spring or a spring tongue.

In a refinement, the contact member includes a ball contacting the inner part of the wheel bearing in the region of its axis of rotation. This ball may in turn be supported by and in rolling contact with a plurality of small balls, such as is the case, for example, in a locking device known from DE 41 03 465 A1.

In a simplified design, the spring of the contact member directly contacts the inner part of the wheel bearing in the region of its axis of rotation. A carbon pin or a carbon element having a different geometry may be used in place of a steel spring or steel ball to equalize the potential between the inner part and the outer part of the wheel bearing. In typical applications, an electrically conductive connection having a resistance on the order of from 10³ to 10⁶ ohms is sufficient to ensure potential equalization. Such a resistance is also achievable using a conductive grease.

The wheel bearing of the device according to the present invention is preferably configured as a double-row rolling element bearing, in particular, a double-row angular contact ball bearing. Such a bearing design is known, for example, from DE 43 39 847 C2.

The present invention may be used equally well in automobiles or trucks and in motor scooters or motor-assisted bicycles, for example.

Various exemplary embodiments of the present invention will be described below in more detail with reference to the drawings, in which:

### BRIEF DESCRIPTION OF THE DRAWINGS

FIG. 1 is a cutaway view of a first exemplary embodiment of a wheel bearing of an electric wheel drive of a motor vehicle;

FIG. 2 is a view similar to FIG. 1 illustrating a second exemplary embodiment of a wheel bearing of an electric wheel drive;

FIG. 3 is a view showing a third exemplary embodiment of a wheel bearing of an electric wheel drive;

FIG. 4 shows a detail from FIG. 3;

FIG. 5 is a cutaway plan view of another exemplary embodiment of a wheel bearing of an electric wheel drive;

FIG. 6 is a cross-sectional view of the arrangement shown in FIG. 5.

### DETAILED DESCRIPTION OF THE DRAWINGS

Like or functionally equivalent parts are identified by the same reference numerals in all figures.

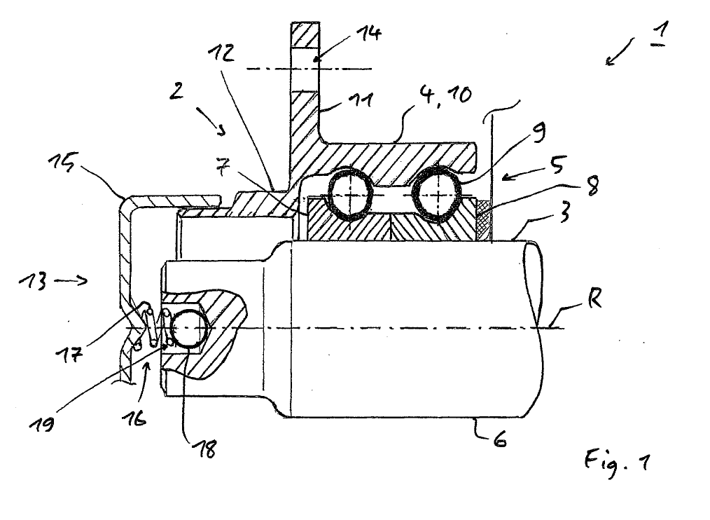

Unless otherwise stated, the following explanations refer to all embodiments shown in FIGS. 1-4.

A wheel bearing 2 is depicted as part of an electric wheel drive which is denoted as a whole by reference numeral 1. As for the basic operating principle of the electric wheel drive, reference is made to the prior art cited at the outset. The wheel bearing includes two parts 3, 4 which are rotatable relative to each other and generally referred to as inner part 3 and outer part 4. The axis of rotation of wheel bearing 2 is designated R. In order to mount outer part 4 such that it is rotatable relative to inner part 3, a rolling element bearing 5 is provided which will be described in greater detail below.

Inner part 3 has a hub 6 on which are held two inner rings 7, 8, one of which may be formed integrally with hub 6. Two rows of rolling elements 9, namely balls, roll on inner rings 7, 8. The races on outer part 4 which are associated with rolling elements 9 are provided by an outer sleeve 10, which merges integrally into a flange 11 and into a sleeve extension 12 directed toward an end face 13 of hub 6. Flange 11 has mounting holes 14 which, depending on the overall design, serve for attachment of wheel bearing 2 to a wheel suspension member or for attachment of a wheel.

A potential equalization element 15 is slipped onto or otherwise attached to sleeve extension 12, said potential equalization element being configured as a cap covering end face 13 of hub 6. At the center of the potential equalization element 15; i.e., in the region of axis of rotation R, the potential equalization element has a contact member 16 which is resilient and, therefore, reliably ensures potential equalization between parts 3, 4 of wheel bearing 2, and thus between different components of electric wheel drive 1 as a whole.

In the exemplary embodiment of FIG. 1, contact member 16 includes a spring 17 in the form of a coil spring 17 as well as a ball 18, said spring pressing said ball 18 into a blind hole 19 formed in end face 13 of hub 6 concentrically with axis of rotation R.

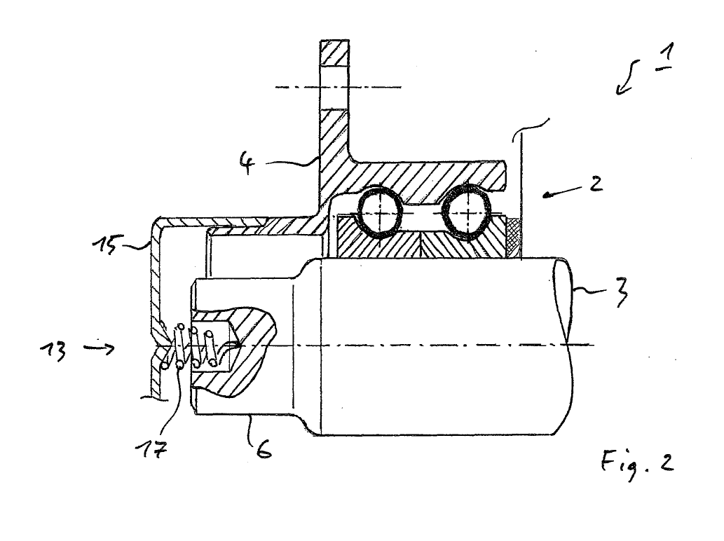

In the exemplary embodiment of FIG. 2, spring 17 is also in the form of a coil spring. In this case, no ball is provided as part of contact member 16, but rather spring 17 contacts hub 6 directly.

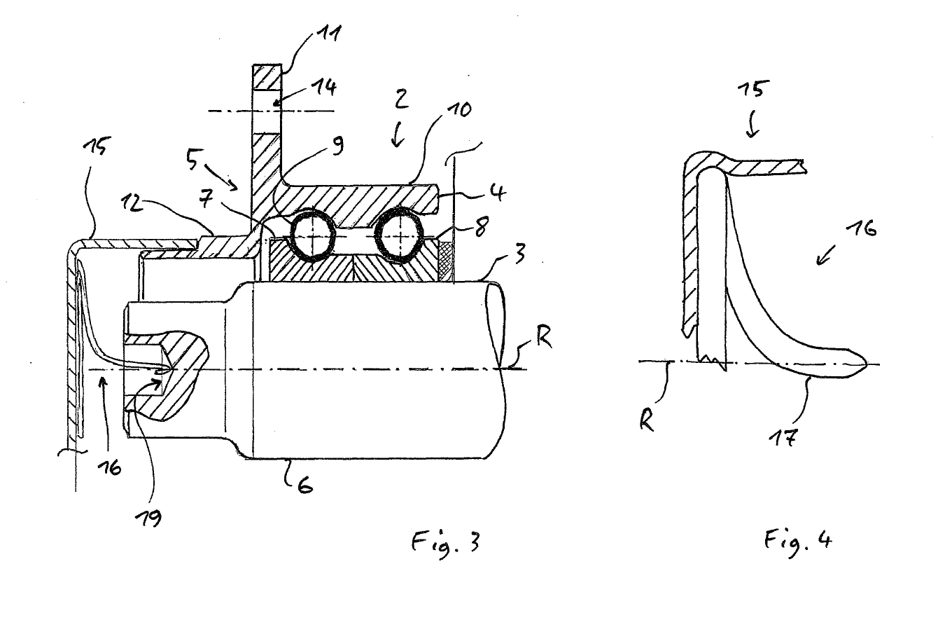

The exemplary embodiment shown in FIGS. 3 and 4 is comparable to that of FIG. 2 in that contact member 16 does not include a ball. In this case, spring 17 takes the form of a spring tongue.

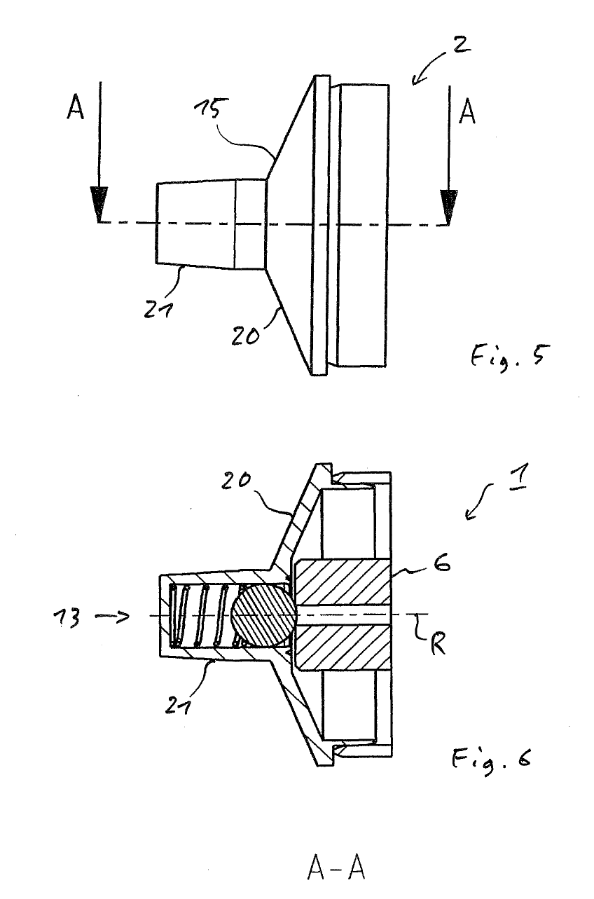

FIGS. 5 and 6 show a possible configuration of potential equalization element 15. With the exception of contact member 16, potential equalization element 15 is integrally made as a single sheet-metal piece, which can be efficiently manufactured by deep drawing. An outer funnel-shaped portion 20 merges into a cup portion 21 at the end face, said cup portion accommodating contact member 16 which, as in the exemplary embodiment of FIG. 1, includes a spring 17 and a ball 18.

### LIST OF REFERENCE NUMERALS

1 electric wheel drive
2 wheel bearing
3 inner part
4 outer part
5 rolling element bearing
6 hub
7 inner ring
8 inner ring
9 rolling element
10 outer sleeve
11 flange
12 sleeve extension
13 end face
14 mounting hole
15 potential equalization element
16 contact member
17 spring
18 ball
19 blind hole
20 funnel-shaped portion
21 cup portion
R axis of rotation

1-10. (canceled)

11. An electric wheel drive comprising:
a wheel bearing having an inner part and an outer part, the outer part rotatable relative to the inner part, the inner part having an end face; and
a potential equalizer attached to the outer part and contacting the end face.

12. The wheel drive as recited in claim 11 wherein the potential equalizer includes a covering cap.

13. The wheel drive as recited in claim 11 wherein the potential equalizer includes a resilient contact member establishing electrically conductive contact between the outer part and the inner part.

14. The wheel drive as recited in claim 13 wherein the contact member includes a spring.

15. The wheel drive as recited in claim 14 wherein the spring is a coil spring.

16. The wheel drive as recited in claim 14 wherein the spring is a spring tongue.

17. The wheel drive as recited in claim 13 wherein the contact member includes a ball contacting the inner part in a region of the axis of rotation of the wheel bearing.

18. The wheel drive as recited in claim 14 wherein the wheel bearing is configured as a double-row rolling element bearing.

19. A method for operating the wheel drive as recited in claim 11 comprising:
operating the electric wheel drive in a motor vehicle.

20. A method for operating the wheel drive as recited in claim 11 comprising:
operating the electric wheel drive in a bicycle having an auxiliary electric drive.
